(19) United States
(12) Patent Application Publication
(10) Pub. No.: US 2024/0393543 A1
(43) Pub. Date: Nov. 28, 2024

(54) PHOTOELECTRIC COMPOSITE CONNECTOR

(71) Applicants: AUTONETWORKS TECHNOLOGIES, LTD., Mie (JP); SUMITOMO WIRING SYSTEMS, LTD., Mie (JP); SUMITOMO ELECTRIC INDUSTRIES, LTD., Osaka (JP)

(72) Inventors: Hiroyoshi MAESOBA, Osaka (JP); Katsuya IKUTA, Osaka (JP); Hidetoshi ISHIDA, Osaka (JP)

(21) Appl. No.: 18/696,270

(22) PCT Filed: Oct. 4, 2022
(86) PCT No.: PCT/JP2022/037080

§ 371 Date: Mar. 27, 2024

(30) Foreign Application Priority Data
Oct. 5, 2021 (JP) 2021-163994

(51) Int. Cl. G02B 6/38; H01R 13/424

(52) U.S. Cl. CPC G02B 6/3817; H01R 13/424

(57) ABSTRACT

A photoelectric composite connector includes an optical ferrule, an electrical connection terminal, a sub-housing and a main housing for accommodating and fixing the sub-housing accommodating the optical ferrule together with the electrical connection terminal. The sub-housing integrally includes an accommodating portion for accommodating the optical ferrule, and a small tube portion provided to project forward from a front end surface of the accommodating portion, a cross-section of the small tube portion orthogonal to a front-rear direction being smaller than the front end surface of the accommodating portion. The main housing includes a housing end surface formed with a through hole at a position in front of the small tube portion of the accommodated sub-housing in a front end part, and an inner contact surface for coming into contact with the front end surface of the accommodating portion.

### TECHNICAL FIELD

The present disclosure relates to a photoelectric composite connector.

### BACKGROUND

An optical cable using an optical fiber is widely used in information communication for household, industry and the like since high-speed communication of a large amount of information is possible. Further, various electronic devices such as a car navigation system are equipped in an automotive vehicle. Optical communication using an optical cable has begun to be used also for communication in those devices. Particularly, the speed up of communication has accelerated in the field of automotive vehicles. There are many problems in carrying out high-speed communication exceeding several Gbps by an electrical cable. With the speed up of communication, optical cables capable of dealing with high-speed communication are becoming more and more important in in-vehicle communication devices. Particularly, an optical cable provided with an optical fiber made of glass can be suitably used in high-speed communication.

On the other hand, an optical cable is not suitable for supplying an energy necessary to operate a communication device, and a wire provided with a metal wire is also used together with the optical cable. Accordingly, to enable an optical cable and a wire to be easily connected to a device such as a communication device, connectors capable of collectively connecting an optical cable and a wire to a device have been and are being developed. Optical-electrical composite connectors of that type are disclosed in patent literature 1 and the like and some have been put to practical use.

### PRIOR ART DOCUMENT

### Patent Document

Patent Document 1: International Publication WO 2007/088863

### SUMMARY OF THE INVENTION

### Problems to be Solved

As described above, photoelectric composite connectors have been and are being developed as a means for collectively connecting an optical cable and a wire to a device such as a communication device, but the composite connectors of that type tend to be difficult to manufacture as compared to optical connectors for connecting only an optical cable and electrical connectors for connecting only a wire. One of reasons for that is that a manufacturing process and a manufacturing facility are normally totally different for optical connectors and for electrical connectors and it is difficult to manufacture a composite connector integrally provided with a connecting portion for an optical cable and a connecting portion for a wire. Particularly, difficulties tend to occur in precisely arranging both an optical communication member such as an optical ferrule and an electrical connecting member such as an electrical connection terminal respectively at predetermined positions and fixing these in a connector housing. Further, with the speed up of communication in automotive vehicles, conventionally used plastic optical fibers (POFs) have been replaced by glass optical fibers (AGFs) in recent years. Since AGFs have a smaller diameter than POFs, an optical communication member for AGF is smaller in size than an optical communication member for POF and it is particularly difficult to precisely arrange the optical communication member for AGF in a connector housing. Moreover, the optical communication member for AGF is required to be arranged with high accuracy to obtain high communication performance.

In view of the above, it is aimed to provide an easily assemblable photoelectric composite connector.

### Means to Solve the Problem

The present disclosure is directed to a photoelectric composite connector with at least one optical ferrule to be coupled to an optical fiber of an optical cable, at least one electrical connection terminal to be coupled to a wire, a sub-housing for accommodating the at least one optical ferrule, and a main housing for accommodating and fixing the sub-housing accommodating the optical ferrule together with the electrical connection terminal, assuming that a direction toward a tip side along an axis of the optical ferrule accommodated in the sub-housing is a forward direction, the sub-housing integrally including an accommodating portion for accommodating the optical ferrule and a small tube portion provided to project forward from a front end surface of the accommodating portion, a cross-section of the small tube portion orthogonal to a front-rear direction being smaller than the front end surface of the accommodating portion, and the main housing including a housing end surface formed with a through hole at a position in front of the small tube portion of the accommodated sub-housing in a front end part and an inner contact surface for coming into contact with the front end surface of the accommodating portion with respect to the sub-housing having the position of the small tube portion aligned with the through hole.

### Effect of the Invention

A photoelectric composite connector according to the present disclosure is an easily assemblable photoelectric composite connector.

### BRIEF DESCRIPTION OF THE DRAWINGS

FIGS. 1A and 1B are perspective views showing a photoelectric composite connector according to one embodiment of a present disclosure entirely, wherein FIG. 1A shows a state when viewed from front and FIG. 1B shows a state when viewed from behind.

FIG. 2 is an exploded perspective view showing the photoelectric composite connector.

FIGS. 3A and 3B are perspective views showing a housing body portion of a main housing, wherein FIG. 3A shows a state when the housing body portion is viewed from front and FIG. 3B shows a state when the housing body portion is viewed from behind.

FIGS. 4A and 4B are perspective views showing a retainer member of the main housing, wherein FIG. 4A shows a state when the retainer member is viewed from front and FIG. 4B shows a state when the retainer member is viewed from behind.

FIG. 5A is a perspective view showing an optical sub-connector and FIG. 5B is a perspective view showing an electrical connection terminal.

FIGS. 6A and 6B are sections showing the photoelectric composite connector, wherein FIG. 6A shows a cross-section along A-A in FIG. 1A corresponding to a center position of the optical sub-connector and FIG. 6B shows a cross-section along B-B in FIG. 1A corresponding to a center position of the electrical connection terminal.

FIG. 7 is a perspective view showing a positional relationship of the retainer member and the optical sub-connector for the photoelectric composite connector.

### DETAILED DESCRIPTION TO EXECUTE THE INVENTION

### Description of Embodiments of Present Disclosure

First, embodiments of the present disclosure are listed and described.

The photoelectric composite connector of the present disclosure is provided with at least one optical ferrule to be coupled to an optical fiber of an optical cable, at least one electrical connection terminal to be coupled to a wire, a sub-housing for accommodating the at least one optical ferrule, and a main housing for accommodating and fixing the sub-housing accommodating the optical ferrule together with the electrical connection terminal, assuming that a direction toward a tip side along an axis of the optical ferrule accommodated in the sub-housing is a forward direction, the sub-housing integrally including an accommodating portion for accommodating the optical ferrule and a small tube portion provided to project forward from a front end surface of the accommodating portion, a cross-section of the small tube portion orthogonal to a front-rear direction being smaller than the front end surface of the accommodating portion, and the main housing including a housing end surface formed with a through hole at a position in front of the small tube portion of the accommodated sub-housing in a front end part and an inner contact surface for coming into contact with the front end surface of the accommodating portion with respect to the sub-housing having the position of the small tube portion aligned with the through hole.

In the above photoelectric composite connector, the optical ferrule is not directly accommodated into the main housing accommodating the electrical connection terminal, but the sub-housing having the optical ferrule accommodated thereinto separately from the electrical connection terminal is accommodated into the main housing. The optical ferrule can be assembled into the sub-housing utilizing conventional manufacturing process and manufacturing facility for optical connectors. A step of directly mounting the sub-housing assembled with the optical ferrule into the main housing together with the electrical connection terminal can be easily performed as compared to a step of directly mounting the optical ferrule into the main housing together with the electrical connection terminal, and the photoelectric composite connector is easily assembled.

Further, in the above photoelectric composite connector, the small tube portion having a smaller cross-section than the front end surface of the accommodating portion is formed in front of the front end surface of the accommodating portion for accommodating the optical ferrule in the sub-housing. The main housing is provided with the inner contact surface, and the inner contact surface comes into contact with the front end surface of the accommodating portion with respect to the sub-housing having the position of the small tube portion aligned with the through hole of the housing end surface. The sub-housing is positioned with respect to the main housing by the contact of the inner contact surface of the main housing with the front end surface of the accommodating portion of the sub-housing. By positioning the sub-housing in this way, a step of assembling the photoelectric composite connector by arranging the sub-housing at a predetermined position of the main housing is easily performed.

Here, the sub-housing may further include a projecting portion projecting outward from an outer peripheral surface in an intermediate part in the front-rear direction of the accommodating portion, the main housing may include an inner projection projecting inward from an inner wall surface in an intermediate part in the front-rear direction, and a rear end part of the projecting portion of the sub-housing and a front end part of the inner projection of the main housing may be in contact with each other with the sub-housing accommodated in the main housing. The sub-housing is positioned with respect to the main housing and retained by the mutual contact of the projecting portion of the sub-housing and the inner projection of the main housing with the sub-housing accommodated in the main housing. In this way, along with a positioning effect by the inner contact surface, the sub-housing is easily positioned and fixed in the main housing and the manufacturability of the photoelectric composite connector is further enhanced.

The electrical connection terminal may have a step structure along the front-rear direction in an intermediate part in the front-rear direction of an outer surface, the main housing may include a locking piece lockable to the step structure while accommodating the electrical connection terminal inside, and the step structure of the electrical connection terminal may be locked by the locking piece of the main housing. The electrical connection terminal is positioned with respect to the main housing by locking the step structure on the outer surface of the electrical connection terminal by the locking piece provided in the main housing with the electrical connection terminal accommodated in the main housing. In this way, not only the sub-housing accommodating the optical ferrule, but also the electrical connection terminal can be easily positioned with respect to the main housing, and the assembly convenience of the entire photoelectric composite connector is enhanced.

In this case, the locking piece may be formed forward of the inner projection in the main housing. Then, the electrical connection terminal is mounted at a position forward of the sub-housing accommodating the optical ferrule in the main housing. Due to differences in the structures and connection modes of the optical ferrule and the electrical connection terminal, it is convenient to provide a connection position of the electrical connection terminal with a mating member provided in a mating connector forward of that of the optical ferrule, and such a relationship of the connection positions is easily realized by setting a positional relationship of the locking piece and the inner projection as described above.

The main housing may be composed of two divided members divided in a direction orthogonal to the front-rear direction, the housing end surface provided with the through hole may be formed on one of the two divided members, and the inner projection when the main housing includes the inner projection or the locking piece when the main housing includes the locking piece may be formed on the other of the two divided members. Then, an operation of accommodating and fixing the sub-housing accommodating the optical ferrule and the electrical connection terminal at predetermined positions inside the main housing can be easily and accurately performed.

In this case, the two divided members may be respectively provided with claw members to be locked to each other at positions forward of the inner projection. Then, the two divided members can be effectively suppressed from being lifted and separated from each other by locking the claw members of the two divided members to each other.

### Details of Embodiment of Present Disclosure

Hereinafter, a photoelectric composite connector according to an embodiment of the present disclosure is described in detail using the drawings. In this specification, terms indicating the shapes and arrangements of members such as a “hollow cylindrical shape,” a “rectangular tube shape,” a “center,” “flush” and “equal” in dimensions include not only geometrically strict concepts, but also errors within a generally allowable range as the photoelectric composite connector.

### <Summary of Structure of Optical-Electrical Composite Connector>

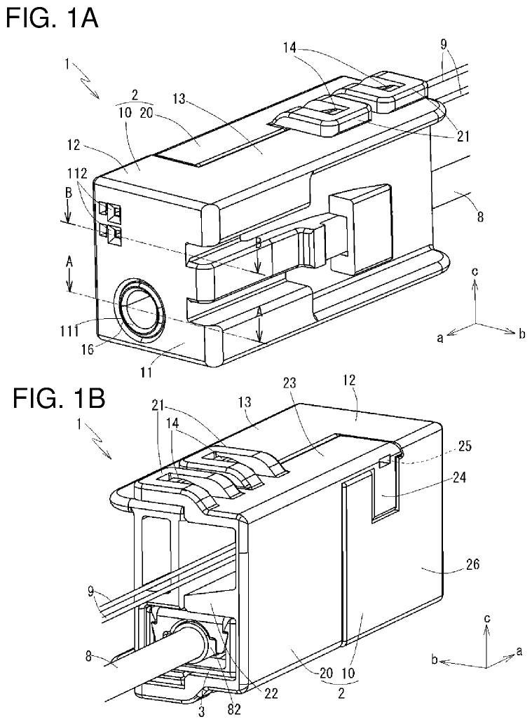

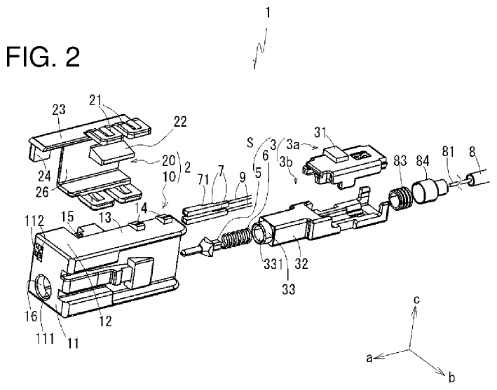

FIGS. 1A, 1B and 2 are perspective views and an exploded perspective view respectively showing a photoelectric composite connector (hereinafter, may be merely referred to as a composite connector) 1 according to one embodiment of the present disclosure. The composite connector 1 according to this embodiment is connected to the tip of an assembly of an optical cable 8 and wires 9 to simultaneously perform optical connection for optical communication and electrical connection for conduction. The composite connector 1 according to this embodiment is not fixed to a member such as a communication device or a printed circuit board, but is configured as a cable connector detachably attachable to a mating connector together with the optical cable 8 and the wires 9.

The composite connector 1 according to this embodiment is provided with at least one optical ferrule 5 as an optical communication part and at least one electrical connection terminal 7 as an electrical connection part. A sub-housing 3 is provided as an accommodating member for accommodating the optical ferrule 5. A spring member 6 is accommodated together with the optical ferrule 5 into the sub-housing 3, thereby configuring an optical sub-connector S. Further, the composite connector 1 is provided with a main housing 2 capable of collectively accommodating the sub-housing 3 and the electrical connection terminals 7, and the sub-housing 3 serving as the optical sub-connector S by having the optical ferrule 5 accommodated thereinto and the electrical connection terminal 7 are accommodated and fixed in the main housing 2. Although the structure of the main housing 2 is described in detail later, the main housing 2 is composed of two divided members including a housing body portion 10 and a retainer member 20.

In this specification, a front-rear direction (a direction) is so specified that a connection direction of the photoelectric composite connector 1 to the mating connector is a forward direction and a connection direction of the optical cable 8 and the wires 9 is a rearward direction. That is, axial directions of the optical ferrule 5 and the electrical connection terminals 7 are the front-rear direction, and tip sides of the optical ferrule 5 and the electrical connection terminals 7 are front sides. A direction, which is orthogonal to the front-rear direction and in which a pair of the electrical connection terminals 7 and the sub-housing 3 accommodating the optical ferrule 5 are arranged in parallel, is a vertical direction (c direction), and a direction orthogonal to the front-rear direction and vertical direction is a width direction (b direction).

The optical ferrule 5 is constituted by a known optical fiber ferrule and an optical cable 8 is fixed thereto. Here, the types of the optical cable 8 and the optical ferrule 5 are not particularly limited, but a cable provided with a glass optical fiber (AGF) is preferably used as the optical cable 8 from the perspective of application to high-speed communication. Generally widely used AGFs have a cladding diameter of 125 μm and, even in the case of a multi-mode type, have a small core diameter of 100 μm or less, and compatible optical ferrules also have a small tip surface area. The optical cable 8 is coupled and fixed to the optical ferrule 5 with an optical fiber 81 exposed in a tip part arranged to be flush with the tip surface of the optical ferrule 5. Further, a cable fixing member composed of a stop ring 83 and a crimp ring 84 is mounted on the tip part of the optical cable 8.

Although one optical ferrule 5 is included in the composite connector 1 in the shown embodiment, a plurality of the optical ferrules 5 may be provided. If the plurality of optical ferrules 5 are provided, each optical ferrule 5 is individually coupled to the optical fiber 81. If the plurality of optical ferrules 5 are included in the composite connector 1, the plurality of optical ferrules 5 may be respectively accommodated into the common sub-housing 3 together with the corresponding spring members 6 to configure the optical sub-connector S. Further, a plurality of the optical sub-connectors S each configured by accommodating one or more pairs of the optical ferrule 5 and the spring member 6 into the sub-housing 3 may be accommodated into the main housing 2.

The electrical connection terminal 7 is configured as an electrical connection terminal for known insulated wire. The electrical connection terminal 7 is fixed to a tip part of the insulated wire 9 and electrically connected to a wire conductor exposed on a tip side of the insulated wire 9. The type of the electrical connection terminal 7 is not particularly limited, but a fitting-type female terminal can be suitably applied as such. Although a pair of (two) electrical connection terminals 7 are included in the composite connector 1 in the shown embodiment, the number of the electrical connection terminals 7 is not particularly limited if at least one electrical connection terminal 7 is included.

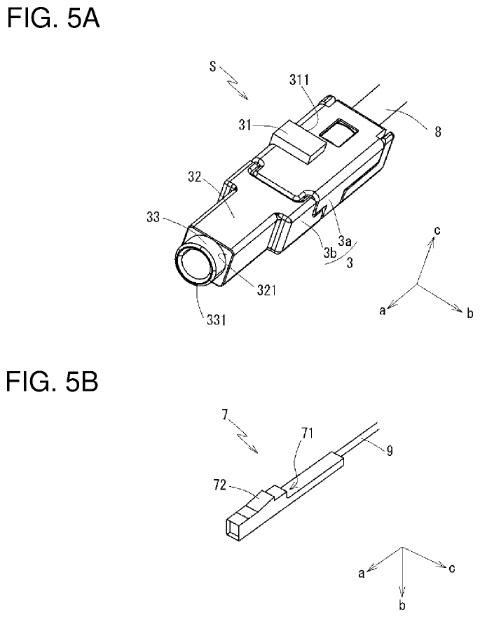

FIG. 5B is a perspective view showing the electrical connection terminal 7. The electrical connection terminal 7 is formed with a step structure 71 on one widthwise outer surface (surface in the −b direction), out of the outer surface. A structure changing a height of the outer surface along the front-rear direction is provided in an intermediate part in the front-rear direction as the step structure 71. Here, a step higher on a front side and lower on a rear side along the front-rear direction is formed as the step structure 71. Further, in the electrical connection terminal 7, a projecting structure 72 projecting to have an acute angle in an intermediate part along the front-rear direction is provided forward of the step structure 71. As described in detail later, the step structure 71 of the electrical connection terminal 7 positions the electrical connection terminal 7 in the main housing 2 by being locked by a terminal locking piece 24 provided in the main housing 2.

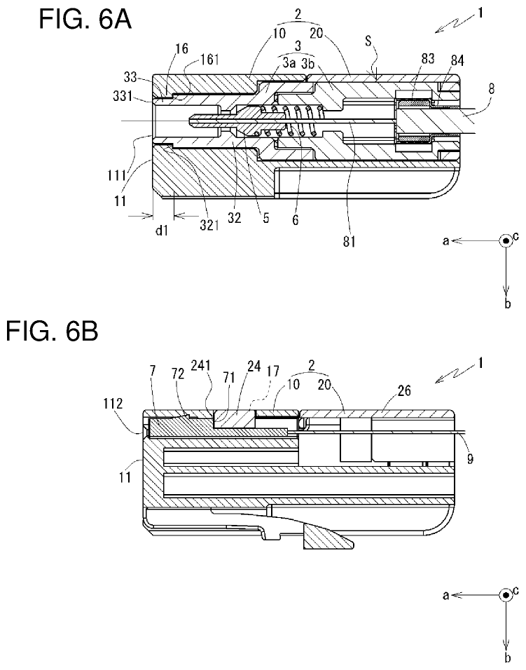

Here, the structures of the sub-housing 3 and the optical sub-connector S are briefly described. FIG. 5A is a perspective view showing the optical sub-connector S. Further, a cross-section of the optical sub-connector S is included in a section of FIG. 6A. As described above, the optical ferrule 5 coupled to the optical cable 8 is accommodated into the sub-housing 3 together with the spring member 6 to configure the optical sub-connector S. The sub-housing 3 serving as an outer shell of the optical sub-connector S is configured as a resin member in the form of a hollow tube having openings on front and rear sides, and can accommodate at least one optical ferrule 5 connected to the optical cable 8 inside. The sub-housing 3 is composed of two divided members including an upper member 3a and a lower member 3b. Out of a coupled body in which the optical ferrule 5 is coupled to the optical cable 8 and the cable fixing member 83, 84 is further mounted, the entire part forward of the cable fixing member 83, 84 is accommodated inside the sub-housing 3.

The sub-housing 3 formed by coupling the upper and lower members 3a, 3b includes a sub-accommodating portion 32 in the form of a rectangular tube. The optical ferrule 5 and the spring member 6 are accommodated in the sub-accommodating portion 32. The optical ferrule 5 is biased forward by the spring member 6 configured as a coil spring in the sub-housing 3. A connection sub-opening 331 is formed as an opening facing the tip surface of the optical ferrule 5 and enabling the entrance of an optical connecting portion of the mating connector including an optical ferrule on the front end of the sub-housing 3. If the mating optical ferrule enters through the connection sub-opening 331 and butts against the optical ferrule in the sub-housing 3, the spring member 6 presses the optical ferrule 5 toward the mating optical ferrule.

The sub-housing 3 has a stepped shape in a tip part and a small tube portion 33 is provided in front of the sub-accommodating portion 32 accommodating the optical ferrule 5 and the spring member 6. The small tube portion 33 is formed as a tubular portion projecting forward from a front end surface (sub-accommodating portion end surface) 321 of the sub-accommodating portion 32. The small tube portion 33 is configured integrally with the sub-accommodating portion 32, and a hollow part of the small tube portion 33 and that of the sub-accommodating portion 32 are continuous. The small tube portion 33 is thinner than the sub-accommodating portion end surface 321 along the front-rear direction. That is, a cross-section of the small tube portion 33 orthogonal to the front-rear direction is smaller than the sub-accommodating portion end surface 321 and has such a shape and size as to fall inside the sub-accommodating portion end surface 321 entirely in the front-rear direction. In the shown embodiment, the small tube portion 33 is formed to have a hollow cylindrical shape. In the sub-housing 3, the tip of the small tube portion 33 serves as the connection sub-opening 331. As described in detail later, the sub-accommodating portion end surface 321 come into contact with a contact portion 16 provided inside the main housing 2 in a boundary part between the small tube portion 33 and the sub-accommodating portion 32, whereby the sub-housing 3 is positioned with respect to the main housing 2.

A locking projecting portion 31 is provided on the outer peripheral surface of the sub-housing 3. The locking projecting portion 31 is provided integrally to the wall surface of the sub-housing 3 (upper member 3a) as a projecting piece projecting upward from the outer upper wall surface of the sub-housing 3 in an intermediate part in the front-rear direction of the sub-accommodating portion 32. In the shown embodiment, the sub-housing 3 is formed as a small piece having a rectangular parallelepiped shape. The locking projecting portion 31 is locked to a locking inner projection 22 provided in the main housing 2 as described in detail later, thereby functioning to position and retain the sub-housing 3 in the main housing 2.

In the composite connector 1 according to this embodiment, the optical ferrule 5 is not directly fixed to the main housing 2, but the optical sub-connector S configured by accommodating the optical ferrule 5 into the sub-housing 3 is assembled with and fixed to the main housing 2 together with the electrical connection terminals 7. In this way, an optical communication part of the composite connector 1 is easily assembled. Normally, a manufacturing process and a manufacturing facility are largely different for optical connectors and electrical connectors and it is difficult to manufacture the connector including both the optical ferrule 5 and the electrical connection terminals 7 in the same manufacturing line. However, if the optical sub-connector S is assembled by accommodating the optical ferrule 5 into the sub-housing 3 and the optical ferrule 5 in the form of the optical sub-connector S is assembled with the main housing 2 as in this embodiment, the assembly of the optical sub-connector S can be performed independently of the assembly of an electrical connecting portion by applying the conventional manufacturing process and manufacturing facility for optical connectors. A step of assembling the thus assembled optical sub-connector S with the main housing 2 together with the electrical connection terminals 7 can be performed without great difficulty by applying the conventional manufacturing process and manufacturing facility for electrical connectors. Particularly, if the optical ferrule 5 has a small diameter for AGF, it tends to be difficult to handle the connector in the assembly process. However, if the optical sub-connector S is assembled in advance, difficulties due to a small diameter of the optical ferrule 5 hardly occur in the assembly process thereafter.

### <Structure and Positioning of Main Housing>

Here, the structure of the main housing 2 and the positioning of the optical sub-connector S and the electrical connection terminals 7 by the main housing 2 are described in detail.

### (Overall Shape of Main Housing)

The main housing 2 is configured as a resin member and accommodates and fixes the optical sub-connector S assembled by accommodating the optical ferrule 5 in the sub-housing 3 and the electrical connection terminals 7 in an internal space. The main housing 2 has a housing end surface 11 as a front end surface, and is configured as a resin member substantially in the form of a rectangular tube open rearward.

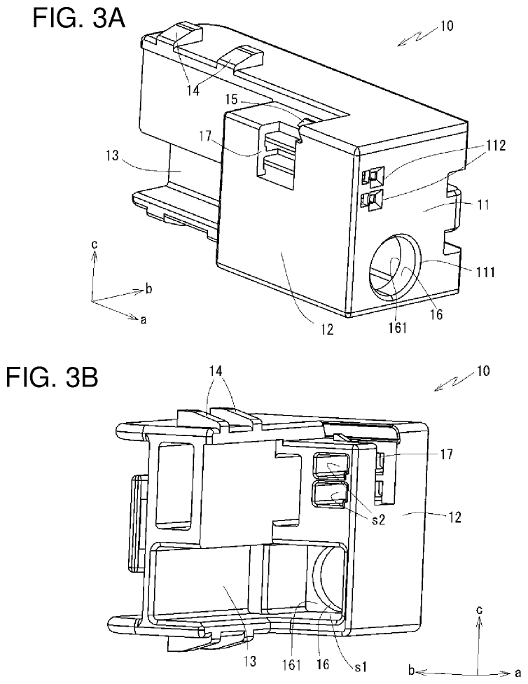

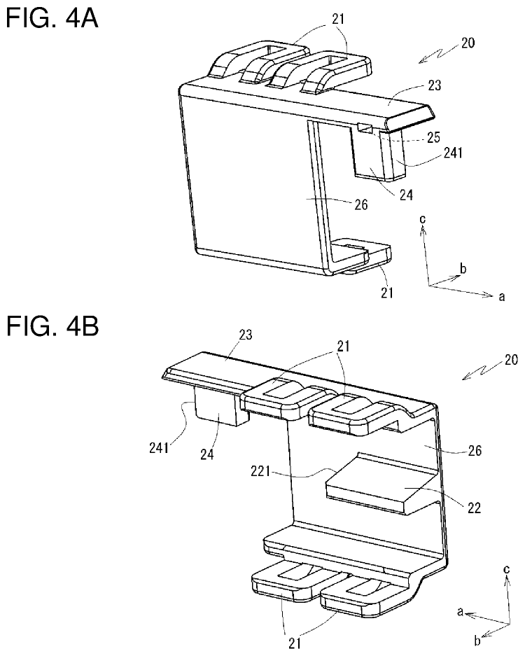

In the embodiment shown in FIGS. 1A and 1B, the main housing 2 is formed into a substantially rectangular tube shape by coupling two divided members including the housing body portion 10 and the retainer member 20. FIGS. 3A, 3B and 4A, 4B are perspective views respectively showing the housing body portion 10 and the retainer member 20 when viewed from front and behind.

The housing body portion 10 includes a tubular portion 12 on a front side and an open portion 13 shaped to be open on one widthwise side (−b direction) integrally with the tubular portion 12 behind the tubular portion 12. A front end surface is provided on the front end of the tubular portion 12, and this front end surface serves as the housing end surface 11, which is the front end surface of the entire main housing 2. The retainer member 20 is for covering the open portion 13 of the housing body portion 10 from a widthwise outer side (−b direction), and the main housing 2 substantially in the form of a rectangular tube is obtained by coupling the retainer member 20 to the open portion 13 of the housing body portion 10.

A coupled state between the housing body portion 10 and the retainer member 20 is held by locking between locking tabs 21 and locking projections 14. The retainer member 20 is provided with the loop-shaped locking tabs 21 on upper and lower wall surfaces. The housing body portion 10 is provided with the locking projections 14 lockable to the locking tabs 21 at positions corresponding to the locking tabs 21 when the retainer member 20 is coupled. By covering the open portion 13 of the housing body portion 10 by the retainer member 20 and locking the loop structures of the locking tabs 21 to the locking projections 14, the housing body portion 10 and the retainer member 20 can be coupled. Locking structures between the locking tabs 21 and the locking projections 14 cannot be easily released once being locked.

Further, the main housing 2 may be auxiliarily provided with members for holding the housing body portion 10 and the retainer member 20 in the coupled state, besides the pairs of the locking tab 21 and the locking projection 14. For example, a pair of claw members lockable to each other in the width direction may be provided at corresponding positions outside the upper or lower wall surface of the housing body portion 10 and inside the upper or lower wall surface of the retainer member 20. In the shown embodiment, one claw member 15 is provided on an outer part to be overlapped with the retainer member 20, out of the upper wall surface of the housing body portion 10, another claw member 25 is provided on the inner surface of an extending portion 23 extending to the position of the tubular portion 12 of the housing body portion 10, out of the upper wall surface of the retainer member 20, and those claw members 15, 25 are locked to each other in the width direction. Such claw members 15, 25 suppress that the retainer member 20 is lifted in the width direction with respect to the housing body portion 10 to apply a force in a direction to separate the retainer member 20 and the housing body portion 10 from each other. In terms of enhancing an effect of suppressing the lift of the retainer member 20, the claw members 15, 25 are preferably provided on a front side of the main housing 2, more preferably forward of the locked positions of the locking tabs 21 and the locking projections 14, further preferably forward of the locked position of the locking inner projection 22 and the locking projecting portion 31 to be described later.

An internal space of the tubular portion 12 of the housing body portion 10 is partitioned into a plurality of spaces by partition walls along the front-rear direction. Out of those spaces, the sub-housing 3 constituting the optical sub-connector S by accommodating the optical ferrule 5 and the like is accommodated into a sub-connector accommodation space s1. Further, the electrical connection terminals 7 connected to the wires 9 are respectively accommodated into two terminal accommodation spaces s2. The electrical connection terminals 7 and the optical ferrule 5 accommodated in the sub-housing 3 are so arranged in the main housing 2 that axial directions thereof are oriented in the front-rear direction. The sub-connector accommodation space s1 and the terminal accommodation spaces s2 are respectively sized and shaped such that the sub-housing 3 and the electrical connection terminals 7 can be accommodated therein without rattling.

An optical connection opening 111 in the form of a through hole is formed in the housing end surface 11 configured as the front end surface of the housing body portion 10. The optical connection opening 111 is provided at a position in front of the small tube portion 33 of the sub-housing 3. The optical connecting portion of the mating connector including the optical ferrule can enter the inside of the sub-housing 3 through the optical connection opening 111 and the connection sub-opening 331. Further, the housing end surface 11 is formed with electrical connection openings 112 at positions in front of the respective electrical connection terminals 7, and electrical connecting portions of the mating connector including electrical connection terminals can enter the terminal accommodation spaces s2.

### (Positioning of Optical Sub-Connector)

Here, the positioning of the optical sub-connector S in the main housing 2 is described. FIG. 6A is a section along A-A in FIG. 1A, i.e. a section of the composite connector 1 cut along a plane perpendicular to the vertical direction passing through a center of the optical sub-connector S (internal structures of the optical ferrule 5 and the optical cable 8 are not shown). The following description is made with reference to FIG. 6A in addition to each figure described above.

As described above, the optical connection opening 111 is formed at the position in front of the small tube portion 33 of the sub-housing 3 in the housing end surface 11 of the housing body portion 10. An opening diameter of the optical connection opening 111 is slightly larger than a diameter of the small tube portion 33 of the sub-housing 3, so that the small tube portion 33 can pass through the optical connection opening 111, but the sub-accommodating portion 32 cannot pass through.

The contact portion 16 is provided integrally with the housing end surface 11 behind the optical connection opening 111. The contact portion 16 is configured as a block-like member including a through hole penetrating in the front-rear direction. The through hole of the contact portion 16 has the same inner diameter as the optical connection opening 111 of the housing end surface 11 and continuous with the optical connection opening 111 in the front-rear direction. The sum (d1 in FIG. 6A) of a thickness (dimension in the front-rear direction) of the contact portion 16 and a plate thickness of the housing end surface 11 is substantially equal to a length along the front-rear direction of the small tube portion 33 of the sub-housing 3. The rear end surface of this contact portion 16 serves as an inner contact surface 161.

In the main housing 2, if the optical sub-connector S is inserted into the sub-connector accommodation space s1 from behind, the small tube portion 33 is inserted into the through hole of the contact portion 16. Then, the inner contact surface 161, which is the rear end surface of the contact portion 16, contacts the sub-accommodating portion end surface 321 (front end surface of the sub-accommodating portion 32) behind the small tube portion 33. At this time, the tip of the small tube portion 33 becomes flush with the housing end surface 11 of the main housing 2. In this way, the sub-housing 3 is positioned with respect to the main housing 2 by contact between the inner contact surface 161 provided in the main housing 2 and the sub-accommodating portion end surface 321 of the sub-housing 3. Further, the sub-housing 3 is prevented from coming out forward from the main housing 2. Since the sub-housing 3 can be positioned only by inserting the small tube portion 33 of the sub-housing 3 into the through hole of the contact portion 16 of the main housing 2 from behind and bringing the sub-accommodating portion end surface 321 into contact with the inner contact surface 161, the sub-housing 3 can be arranged at a proper position and a holding operation can be easily performed in assembling the optical sub-connector S with the main housing 2.

Further, the main housing 2 is provided with the locking inner projection 22 as a member for further enhancing the holding reliability of the optical sub-connector S positioned utilizing the contact between the inner contact surface 161 and the sub-accommodating portion end surface 321 as described above. The locking inner projection 22 is provided inside a closing surface 26 of the retainer member 20. Here, the closing surface 26 of the retainer member 20 is a surface located on the widthwise outer side (−b direction) of the housing body portion 10 for closing the open portion 13 of the housing body portion 10. The locking inner projection 22 is provided as a block-like small piece projecting inward in the width direction (+b direction) from the inner wall surface of the closing surface 26 of the retainer member 20 in an intermediate part in the front-rear direction of the main housing 2. The locking inner projection 22 becomes a member projecting inwardly of the main housing 2 when the retainer member 20 is coupled to the housing body portion 10.

If the retainer member 20 is attached to the housing body portion 10 with the sub-accommodating portion end surface 321 of the sub-housing 3 held in contact with the inner contact surface 161 and the optical sub-connector S positioned in the housing body portion 10, the position of the locking inner projection 22 of the retainer member 20 corresponds to that of the locking projecting portion 31 projecting outward in the width direction (−b direction) from the side wall surface of the accommodated sub-housing 3. More particularly, the position of the locking inner projection 22 is set such that the position of a rear end part 311 of the locking projecting portion 31 corresponds to that of a front end part 221 of the locking inner projection 22.

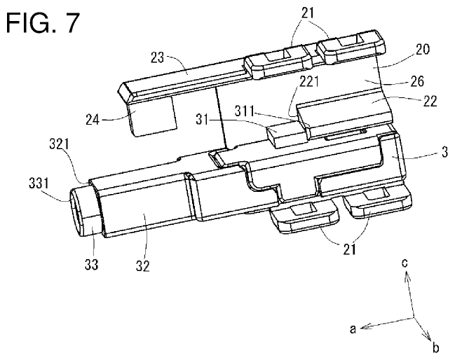

FIG. 7 is a perspective view showing a positional relationship of the retainer member 20 and the sub-housing 3, focusing on the locked position of the locking projecting portion 31 and the locking inner projection 22. Here, the rear end part 311 of the locking projecting portion 31 and the front end part 221 of the locking inner projection 22 come into contact with each other since the positions of the locking projecting portion 31 and the locking inner projection 22 are set as described above. The locking projecting portion 31 and the locking inner projection 22 are locked to each other in the front-rear direction by this contact between the locking projecting portion 31 and the locking inner projection 22.

This locking structure between the locking projecting portion 31 and the locking inner projection 22 increases the positioning reliability of the optical sub-connector S in the main housing 2 in addition to the positioning by the contact between the sub-accommodating portion end surface 321 and the inner contact surface 161 in the front part of the sub-housing 3. Further, the thus positioned optical sub-connector S is retained by locking between the locking projecting portion 31 and the locking inner projection 22 and prevented from coming out rearward from the main housing 2. In this way, a step of arranging and fixing the optical sub-connector S at a predetermined position of the main housing 2 can be easily performed and the optical sub-connector S is stably held at a predetermined position in the main housing 2 in the manufactured composite connector 1. Further, the locking inner projection 22 has a long shape along the front-rear direction and doubles as a partition wall defining the sub-connector accommodation space s1 by being continuous with the partition wall provided in the tubular portion 12 of the housing body portion 10 in the main housing 2.

### (Positioning of Electrical Connection Terminals)

Next, the positioning of the electrical connection terminals 7 in the main housing 2 is described. FIG. 6B is a section along B-B in FIG. 1A, i.e. a section of the composite connector 1 cut along a plane perpendicular to the vertical direction passing through a center of one electrical connection terminal 7 (internal structures of the electrical connection terminal 7 and the wire 9 are not shown). The following description is made with reference to FIG. 6B in addition to each figure described above.

The retainer member 20 constituting the main housing 2 includes the extending portion 23 having the upper wall surface extending forward. The extending portion 23 extends further forward than the closing surface 26 for closing the open portion 13 of the housing body portion 10 and extends to an intermediate part in the front-rear direction of the tubular portion 12 of the housing body portion 10. The terminal locking piece 24 is provided integrally with the extending portion 23 on a front part of the extending portion 23. The terminal locking piece 24 is configured as a plate-like small piece projecting downward from the extending portion 23. The widthwise outer surface of the terminal locking piece 24 is flush with that of the closing surface 26, but a plate thickness of the terminal locking piece 24 is larger than that of the closing surface 26. A window portion 17 serving as a through hole, into which the terminal locking piece 24 is insertable, is provided at a position where the terminal locking piece 24 is located when the retainer member 20 is coupled, out of the side wall surface of the housing body portion 10. When the retainer member 20 is coupled to the housing body portion 10, the terminal locking piece 24 projects inward (+b direction) from the side wall surface of the main housing 2 by a plate thickness difference from the closing surface 26 via the window portion 17.

The position of the terminal locking piece 24 corresponds to the positions of the step structures 71 of the electrical connection terminals 7 when the retainer member 20 is attached by inserting the electrical connection terminals 7 into the terminal accommodation spaces s2 of the tubular portion 12 of the housing body portion 10. More particularly, the position of the terminal locking piece 24 in the retainer member 20 is set such that the position of the front end part 241 of the terminal locking piece 24 correspond to the positions of the step structures 71 of the electrical connection terminals 7, i.e. the positions of the steps changing the heights from the front side toward the rear side, with the electrical connection terminals 7 inserted in the terminal accommodation spaces s2 until the electrical connection terminals 7 contact the housing end surface 11. Further, the heights of the steps in the step structures 71 are equal to a projection height of the terminal locking piece 24 from the inner side surface of the main housing 2.

By setting the positional relationship of the terminal locking piece 24 and the step structures 71 of the electrical connection terminals 7 as described above, the terminal locking piece 24 is locked to the step structures 71 of the electrical connection terminals 7 along the front-rear direction in the composite connector 1 as shown in FIG. 6B. Further, the terminal locking piece 24 comes into contact with the outer surfaces behind the step structures 71 of the electrical connection terminals 7 (lowered parts via the steps). This locking structure between the terminal locking piece 24 and the step structures 71 of the electrical connection terminals 7 position the electrical connection terminals 7 in the main housing 2. The terminal locking piece 24 has such a vertical dimension as to extend over both of the two electrical connection terminals 7 arranged in parallel, one terminal locking piece 24 can be locked to the step structures 71 of the two electrical connection terminals 7 and simultaneously position the two electrical connection terminals 7. Note that the electrical connection terminal 7 is provided with the projecting structure 72 in a part forward of the step structure 71, and the electrical connection terminal 7 is temporarily locked in the main housing 2 by this projecting structure 72 biting into the inner wall surface of the housing body portion 10 during the insertion of the electrical connection terminal 7 into the terminal accommodation space s2. Thereafter, the electrical connection terminal 7 is firmly fixed at a predetermined position in the main housing 2 by the terminal locking piece 24.

In the retainer member 20, the terminal locking piece 24 to be locked to the step structures 71 of the electrical connection terminals 7 is formed forward of the locking inner projection 22 to be locked to the locking projecting portion 31 of the sub-housing 3 constituting the optical sub-connector S in the composite connector 1. In this way, a position where the electrical connection terminal 7 is electrically connected to the electrical connection terminal of the mating connector is set forward of a position where the optical ferrule 5 is optically connected to the optical ferrule of the mating connector. Since the electrical connection terminal 7 has a simple connection structure of being directly coupled to the tip of the wire 9 and is connected to the mating electrical connection terminal by male-female fitting, electrical connection is established at a shallow position on the front side of the main housing 2. In contrast, since the optical ferrule 5 is not simply coupled to the tip of the optical cable 8, but requires the arrangement of the spring member 6 and the cable fixing member 83, 84 near the optical ferrule 5 and is connected to the mating optical ferrule with the tip surfaces of the both optical ferrules butting against each other, it is preferable to establish optical connection at a deep position in the main housing 2. By providing the terminal locking piece 24 forward of the locking inner projection 22 as described above, the composite connector 1 in which electrical connection by the electrical connection terminals 7 is established forward of optical connection by the optical ferrule 5 can be constructed by a simple configuration.

In assembling the composite connector 1, the optical sub-connector S assembled in advance and the electrical connection terminals 7 coupled to the wires 9 are respectively inserted into the sub-connector accommodation space s1 and the terminal accommodation spaces s2 of the housing body portion 10 from behind. At this time, the optical sub-connector S is positioned by inserting the small tube portion 33 of the sub-housing 3 into the through hole of the contact portion 16 and bringing the sub-accommodating portion end surface 321 into contact with the inner contact surface 161. Further, the electrical connection terminals 7 are temporarily locked by the projecting structures 72 at the positions where the tips thereof are in contact with the housing end surface 11. Subsequently, the retainer member 20 is attached to close the open portion 13 of the housing body portion 10 by the closing surface 26 of the retainer member 20. At this time, the locking inner projection 22 provided inside the closing surface 26 is locked to the locking projecting portion 31 of the sub-housing 3, and the terminal locking piece 24 is locked to the step structures 71 of the two electrical connection terminals 7. Further, the claw member 15 of the housing body portion 10 and the claw member 25 of the retainer member 20 are locked to each other. In this way, by forming the locking structure in each part and locking the locking tabs 21 of the retainer member 20 to the locking projections 14 of the housing body portion 10, the housing body portion 10 and the retainer member 20 are coupled. In this way, the composite connector 1 in which the optical ferrule 5 and the electrical connection terminals 7 are accommodated at the predetermined positions in the main housing 2 can be easily manufactured.

### OTHER EMBODIMENTS

In the embodiment described above, the main housing 2 is composed of the housing body portion 10 and the retainer member 20 divided in the width direction and, out of those, the retainer member 20 is provided with the locking inner projection 22 for holding the optical sub-connector S and the terminal locking piece 24 for holding the electrical connection terminals 7. By adopting this configuration, an operation of arranging and fixing the optical sub-connector S and the electrical connection terminals 7 at the predetermined positions inside the tubular main housing 2 is easily performed. However, the main housing 2 needs not necessarily be divided into a plurality of divided members. Further, even if the main housing 2 is divided into divided members, a division mode may be different from the above one such as a division mode in the front-rear direction. Further, if the main housing 2 is composed of two divided members divided in the width direction as described above, each of the locking inner projection and the terminal locking piece may be provided on either one of the divided members and the both may be provided on the same divided member or may be provided on different divided members. However, by providing the locking inner projection 22 and the terminal locking piece 24 on a common divided member (retainer member 20 in the above case) and providing those locking inner projection 22 and terminal locking piece 24 on the divided member (retainer member 20 in the above case) different from the divided member having the housing end surface 11 (housing body portion 10 in the above case), the locking structures for the optical sub-connector S and the electrical connection terminals 7 by those members 22, 24 can be easily formed.

Further, as described above, the type and number of the electrical connection terminals 7 are not particularly limited. For example, either ordinary terminals not supposed to comply with specific standards or terminals satisfying predetermined standards such as Ethernet (registered trademark) standards may be used as the electrical connection terminals 7. The use of ordinary terminals is better due to low cost and the use of terminals satisfying predetermined standards is better in being able to ensure performances of the electrical connecting portions such as communication performance.

In the case of providing a plurality of the electrical connection terminals 7, an arrangement direction of those electrical connection terminals 7 is also not particularly limited. In the above embodiment, the pair of electrical connection terminals 7 are arranged in the vertical direction (c direction) together with the sub-housing 3 accommodating the optical ferrule 5 (hereinafter, referred to as “series arrangement”) as described above. However, for example, the pair of electrical connection terminals 7 arranged in the width direction (b direction) and the sub-housing 3 accommodating the optical ferrule 5 may be arranged in the vertical direction (c direction) (hereinafter, referred to as “parallel arrangement”). Which of the series arrangement and the parallel arrangement should be adopted may be selected according to the use application of the composite connector 1, the type of the electrical connection terminals 7 and the like. Further, the composite connector according to this embodiment is a cable connector and the series arrangement or the parallel arrangement may be selected in accordance with the arrangement of electrical connecting portions and an optical connecting portion of a mating connector to be connected such as a board connector (PCB connector). However, the parallel arrangement is better in space saving since the entire composite connector 1 is set to have a small size.

Further, although waterproofness is not given to the composite connector 1 in the above embodiment, the composite connector 1 may be configured as a waterproof connector. For example, it is considered to close the rear end opening of the main housing 2 by a waterproof plug.

The present invention is not limited at all by the above embodiment and various modifications can be made without departing from the gist of the present invention.

### LIST OF REFERENCE NUMERALS

1 (photoelectric) composite connector
2 main housing
3 sub-housing
3a upper member
3b lower member
5 optical ferrule
6 spring member
7 electrical connection terminal
8 optical cable
9 (insulated) wire
10 housing body portion
11 housing end surface
111 optical connection opening
112 electrical connection opening
12 tubular portion
13 open portion
14 locking projection
15 claw member
16 contact portion
161 inner contact surface
17 window portion
20 retainer member
21 locking tab
22 (locking) inner projection
221 front end part of (locking) inner projection
23 extending portion
24 terminal locking piece
241 front end part of terminal locking piece
25 claw member
26 closing surface
31 (locking) projecting portion
311 rear end part of (locking) projecting portion
32 (sub)-accommodating portion
321 sub-accommodating portion end surface (=front end surface of sub-accommodating portion)
33 small tube portion
331 connection sub-opening
71 step structure of electrical connection terminal
72 projecting structure
81 optical fiber
83 stop ring
84 crimp ring
a front-rear direction
b width direction
c vertical direction
d1 total thickness of contact portion and housing end surface
s1 sub-connector accommodation space
s2 terminal accommodation space
S optical sub-connector

1. A photoelectric composite connector, comprising:
at least one optical ferrule to be coupled to an optical fiber of an optical cable;
at least one electrical connection terminal to be coupled to a wire;
a sub-housing for accommodating the at least one optical ferrule; and
a main housing for accommodating and fixing the sub-housing accommodating the optical ferrule together with the electrical connection terminal,
assuming that a direction toward a tip side along an axis of the optical ferrule accommodated in the sub-housing is a forward direction,
the sub-housing integrally including:
an accommodating portion for accommodating the optical ferrule; and
a small tube portion provided to project forward from a front end surface of the accommodating portion, a cross-section of the small tube portion orthogonal to a front-rear direction being smaller than the front end surface of the accommodating portion, and
the main housing including:
a housing end surface formed with a through hole at a position in front of the small tube portion of the accommodated sub-housing in a front end part; and
an inner contact surface for coming into contact with the front end surface of the accommodating portion with respect to the sub-housing having the position of the small tube portion aligned with the through hole.

2. The photoelectric composite connector according to claim 1, wherein:
the sub-housing further includes a projecting portion projecting outward from an outer peripheral surface in an intermediate part in the front-rear direction of the accommodating portion,
the main housing includes an inner projection projecting inward from an inner wall surface in an intermediate part in the front-rear direction, and
a rear end part of the projecting portion of the sub-housing and a front end part of the inner projection of the main housing are in contact with each other with the sub-housing accommodated in the main housing.

3. The photoelectric composite connector according to claim 1, wherein:
the electrical connection terminal has a step structure along the front-rear direction in an intermediate part in the front-rear direction of an outer surface,
the main housing includes a locking piece lockable to the step structure while accommodating the electrical connection terminal inside, and
the step structure of the electrical connection terminal is locked by the locking piece of the main housing.

4. The photoelectric composite connector according to claim 3, wherein the locking piece is formed forward of the inner projection in the main housing.

5. The photoelectric composite connector according to claim 2, wherein:
the main housing is composed of two divided members divided in a direction orthogonal to the front-rear direction,
the housing end surface provided with the through hole is formed on one of the two divided members, and
the inner projection is formed on the other of the two divided members.

6. The photoelectric composite connector according to claim 3, wherein:
the main housing is composed of two divided members divided in a direction orthogonal to the front-rear direction,
the housing end surface provided with the through hole is formed on one of the two divided members, and
the locking piece is formed on the other of the two divided members.

7. The photoelectric composite connector according to claim 5, wherein the two divided members are respectively provided with claw members to be locked to each other at positions forward of the inner projection.
